(19) United States
(12) Patent Application Publication
(10) Pub. No.: US 2013/0241978 A1
(43) Pub. Date: Sep. 19, 2013

(54) Printing Apparatus and Method

(71) Applicant: PMP J PTY LTD, Warrandyte North (AU)

(72) Inventor: Peter John Clark, Warrandyte North (AU)

(73) Assignee: PMP J Pty Ltd, Warrandyte North (AU)

(21) Appl. No.: 13/675,795

(22) Filed: Nov. 13, 2012

Related U.S. Application Data
(60) Provisional application No. 61/611,619, filed on Mar. 16, 2012.

(51) Int. Cl. B41J 3/44

(52) U.S. Cl. CPC B41J 3/44
USPC 347/2

(57) ABSTRACT

A mounting arrangement (1) for integrating one or more ink jet printheads (6) with an existing primary web or sheet press or the like, the mounting arrangement (1) including a printhead gantry (4) adapted for positioning intermediate the reel stand/splicer (2) and printing unit (3) of the primary press, a mounting carriage (7) fitted to the printhead gantry (4) and adapted to receive and position the printhead (6) to intercept the paper, including cardboard (or other substrates) (5) fed from the reel stand/splicer (2), a drying arrangement (13) adapted to dry the ink jet printing, rollers (10) adapted to intercept and direct the paper feed from the feed roller (2) past the printhead (6) and drying arrangement (13), and a tensioning arrangement to return the ink jet printed paper to the primary press under appropriate tension.

### INTRODUCTION TO INVENTION

This invention relates to applications of recently developed continuous ink jet printheads including the KODAK® brand PROSPER Imprinting System S5, S10, S20 and S30 and other brands and types of ink jet systems such as drop on demand and the like with existing primary printing systems of the like of high speed heat set web offset presses, gravure presses, flexographic presses, cardboard plastic printing presses and other types of presses including sheet fed presses.

The invention also relates to the integration of ink jet printheads with newly manufactured presses.

### BACKGROUND TO INVENTION

The advent of high speed continuous, drop on demand and similar ink jet printheads has provided a means of applying personalised and versioned printing of high quality and with great accuracy at speeds to match traditional offset and other web printing presses.

The current technology available from such printheads is well adapted for applying small areas of printing to compliment the large broadsheet printing available from traditional web printing presses.

The ability to apply such printing in small, readily controlled and modified batches, including the ability to readily set up changes with minimal fuss, lends itself to the integration of such printheads with traditional presses where large print runs can be augmented with personalised printing in sub batches of any size within a given print run. Moreover, the integration of printheads allows each individual printed piece or any combination/grouping of the printed material to be personalized with any specific information including sequential numbers, barcodes, QR codes, random numbers, addresses, alpha numeric codes etc.

To date the integration of such printheads with existing presses has been limited to bulky printhead carriage stations of the like of Kodak Versamount™ DC3800. Such after-market stations require substantial physical realignment of the existing press components, including post printing manipulation and packaging systems, and do not lend themselves to integration early in the printing schedule of such presses.

One object of the invention is to provide a simplified and improved integration of ink jet printheads with traditional printing presses.

### STATEMENT OF INVENTION

In a first aspect the invention provides a mounting means for integrating one or more ink jet printheads with an existing primary web or sheet press or the like for printing on substrate fed into said press prior to application of primary printing, said mounting means comprising a printhead gantry adapted for positioning intermediate the infeed unit of the reel stand/splicer and first or subsequent print unit of said primary press, a mounting carriage fitted to said printhead gantry and adapted to receive and position said printhead for movement across the path of said substrate to intercept the paper, cardboard or other substrates fed from said infeed unit of the reel stand/splicer, dryers associated with each printhead for movement corresponding to movement of said printhead across the path of said substrate adapted to dry said ink jet printing prior to application of primary printing, rollers adapted to intercept and direct said substrate feed from said reel stand/splicer past said printhead and dryers, and tensioning means to return said ink jet printed substrate to said primary press under appropriate tension.

The mounting means may include a manual or servo driven lateral adjustment means allowing precise positioning of said printhead transversely across the path of said substrate.

The mounting means may include lateral slides fitted to said printhead gantry via a lateral slide carriage allowing complete transverse displacement of said fitted head from the substrate path and associated primary press.

The rollers may include a head roller positioned directly under said fitted head.

The mounting means may preferably include a dryer gantry adapted to receive and position the dryers for co-operation with each printhead.

The printhead gantry may include a transverse mounting carriage for fitting of the printheads. The transverse mounting carriage may be adapted to position the printhead for movement above (over) or below (under) the substrate path so as to apply printing to the top or bottom of the substrate.

The transverse mounting carriage may co-operate with the lateral slides for fitting the printheads for movement between a printing position over or under the substrate path and a maintenance position away from the substrate path.

The lateral slide carriage may also include a lateral adjustment screw to position the printhead across the substrate path. The adjustment screw may be motorised.

The drying gantry may include transverse rails for mounting dryers for positioning across the substrate path, preferably aligned with the printheads.

In another aspect the invention provides a combination of a primary press for applying primary printing to a substrate and an ink jet printhead for applying secondary printing to said substrate, characterised in that said printhead is integrated with said primary press via a mounting means as previously described.

In another aspect the invention provides a method of integrating an ink jet printhead to a primary press including the use of a mount means as previously described.

### DETAILED DESCRIPTION OF INVENTION

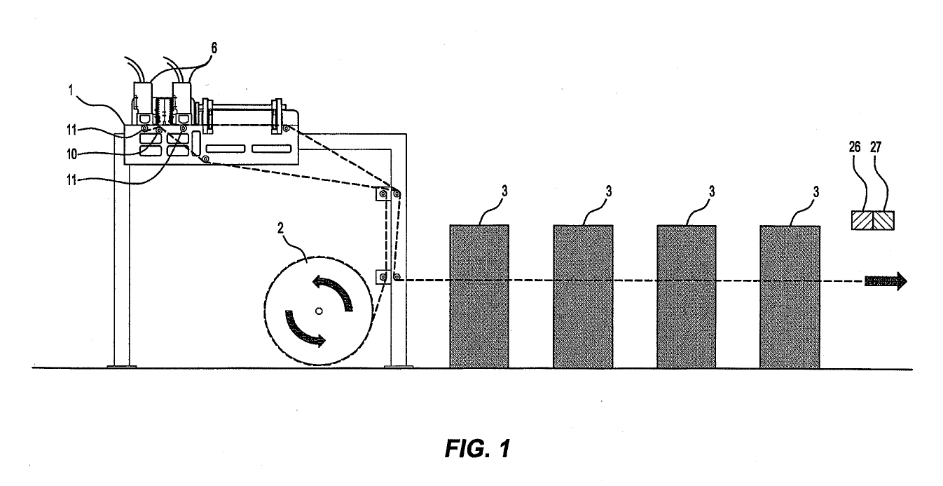

The invention will now be described with reference to one particularly preferred embodiment with the integration of a Kodak® Prosper™ ink jet printhead with a web offset printing press as shown in FIGS. 1 to 18 and the accompanying legend.

FIG. 1 shows a side overview of a traditional heat set web offset press with the integrated printhead.

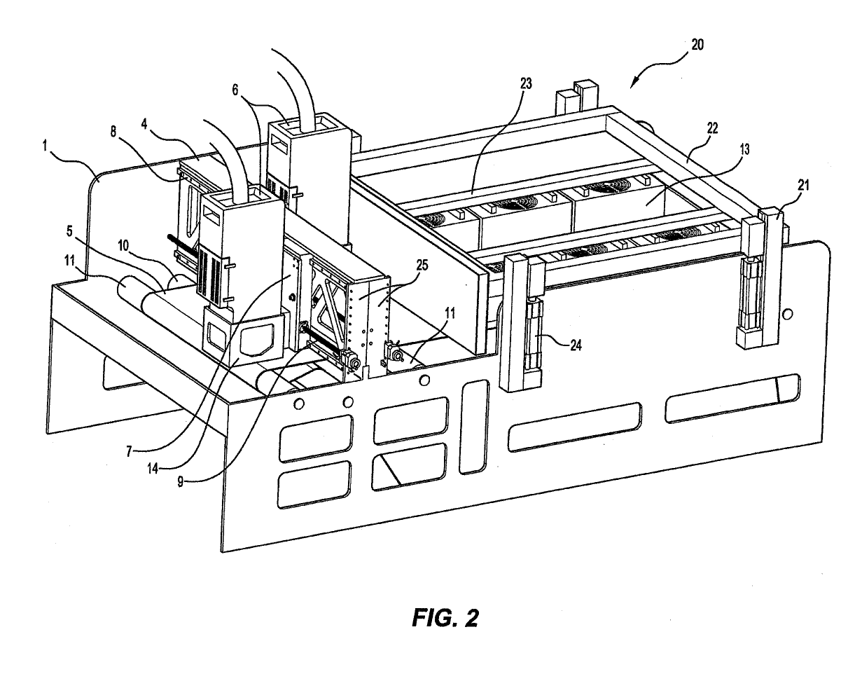

FIG. 2 shows a left perspective view of the mounting means of the invention incorporating a single printhead gantry.

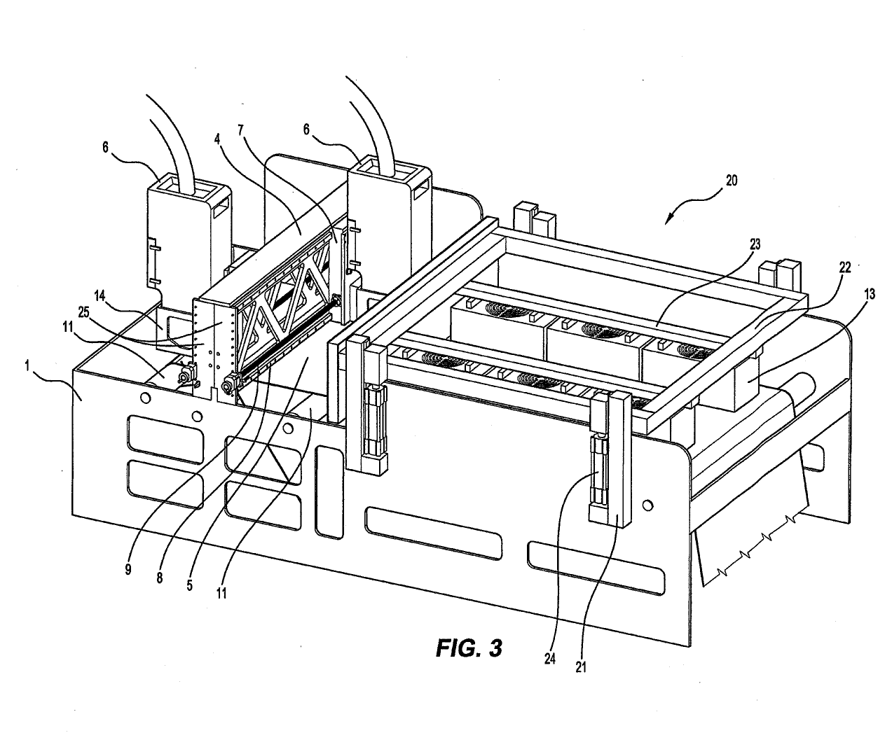

FIG. 3 shows a right perspective view of the mounting means of the invention incorporating a single printhead gantry.

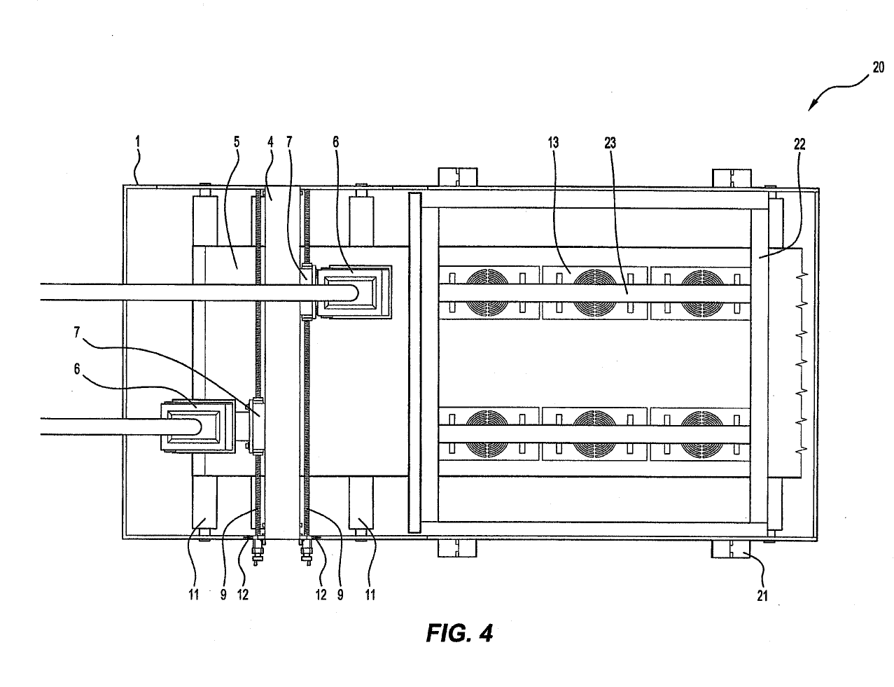

FIG. 4 shows a plan view of the mounting means of the invention.

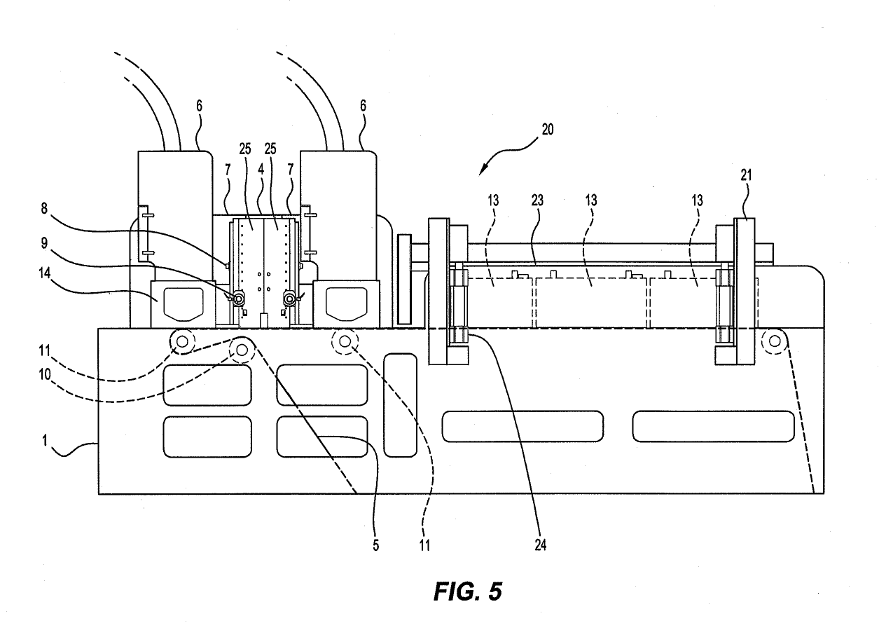

FIG. 5 shows a side view of the mounting means of the invention.

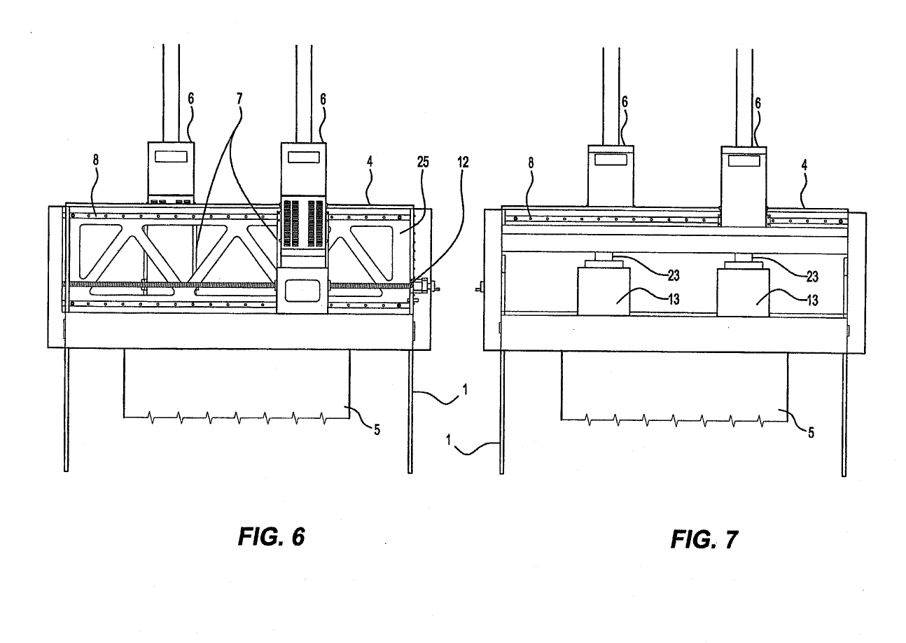

FIGS. 6 and 7 show end views of the mounting means of the invention.

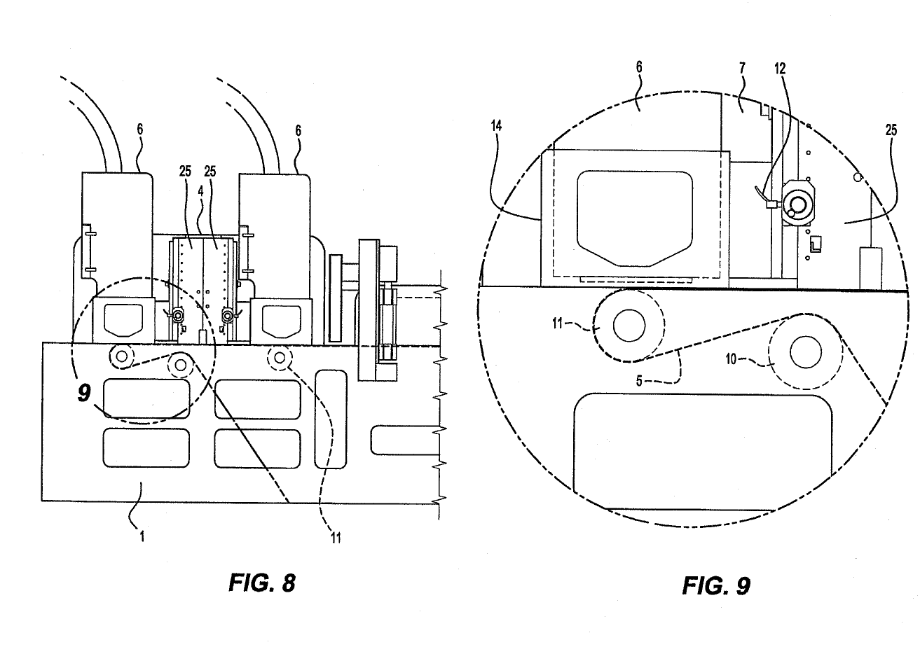

FIGS. 8 and 9 show detail of the paper/substrate path and rollers.

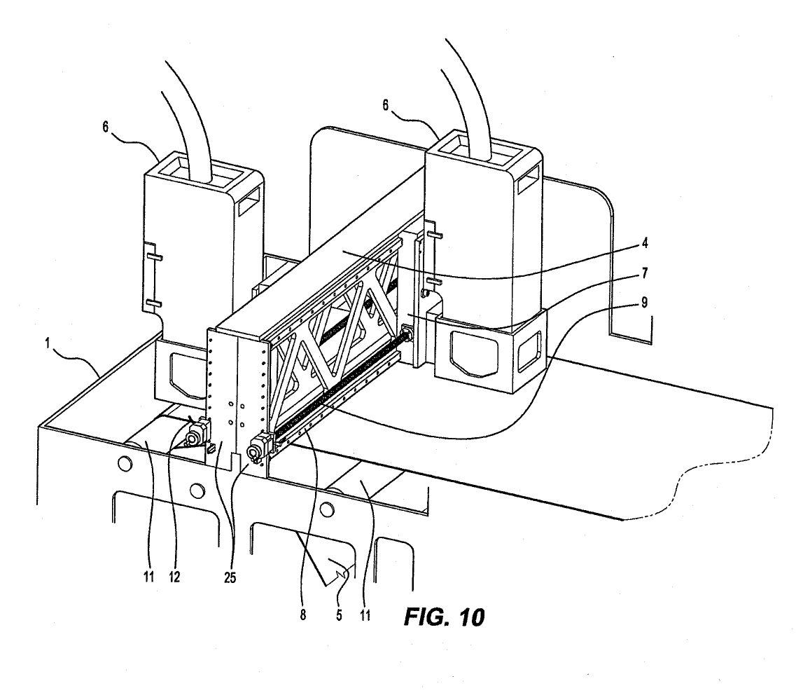

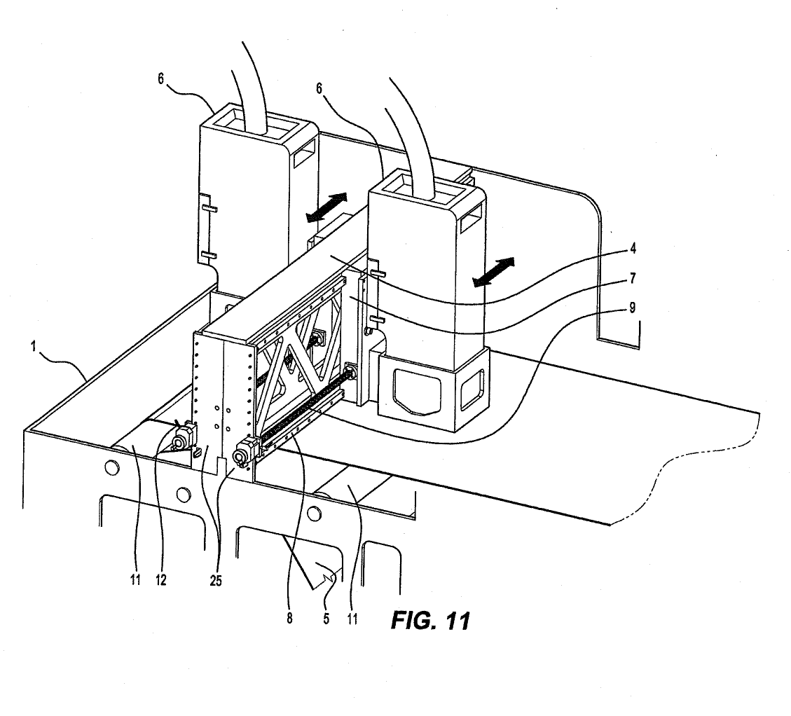

FIGS. 10 and 11 show detail of the printhead gantry and transverse motion of the printhead.

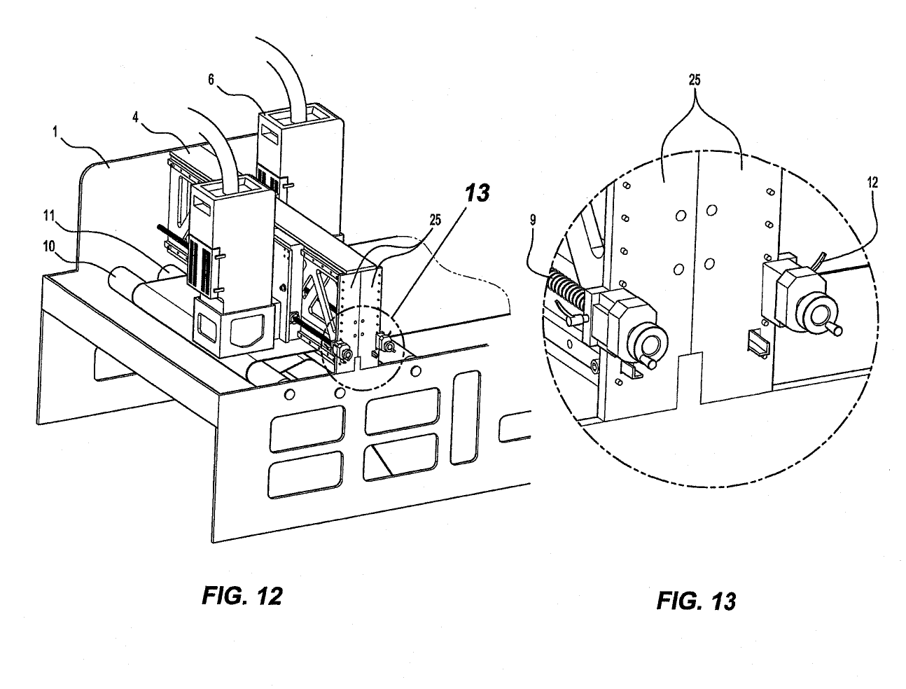

FIGS. 12 and 13 show detail of the lateral adjustment of the lateral slide carriage.

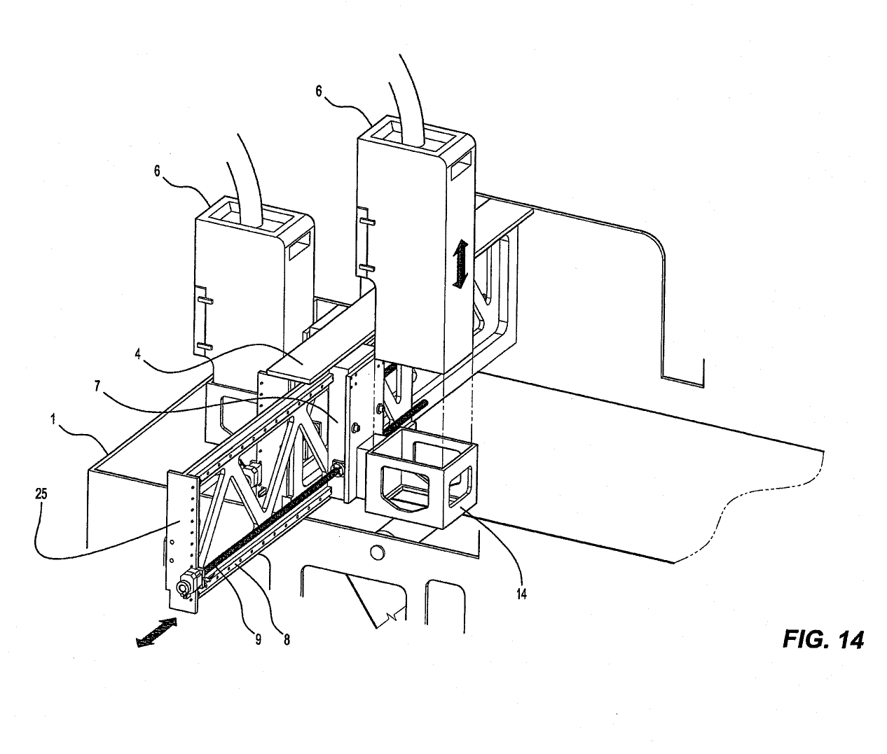

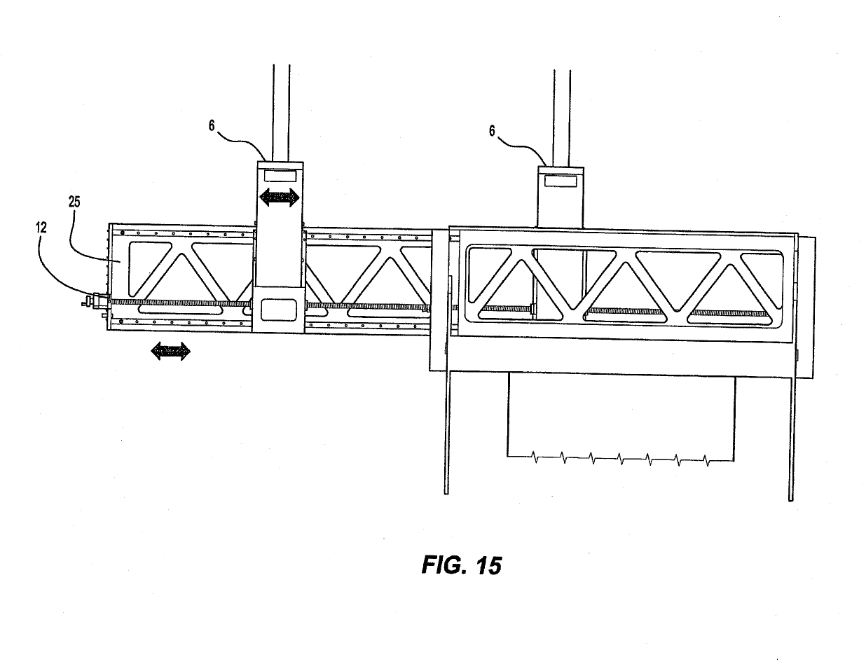

FIG. 14 shows removal of the printhead from the carriage.

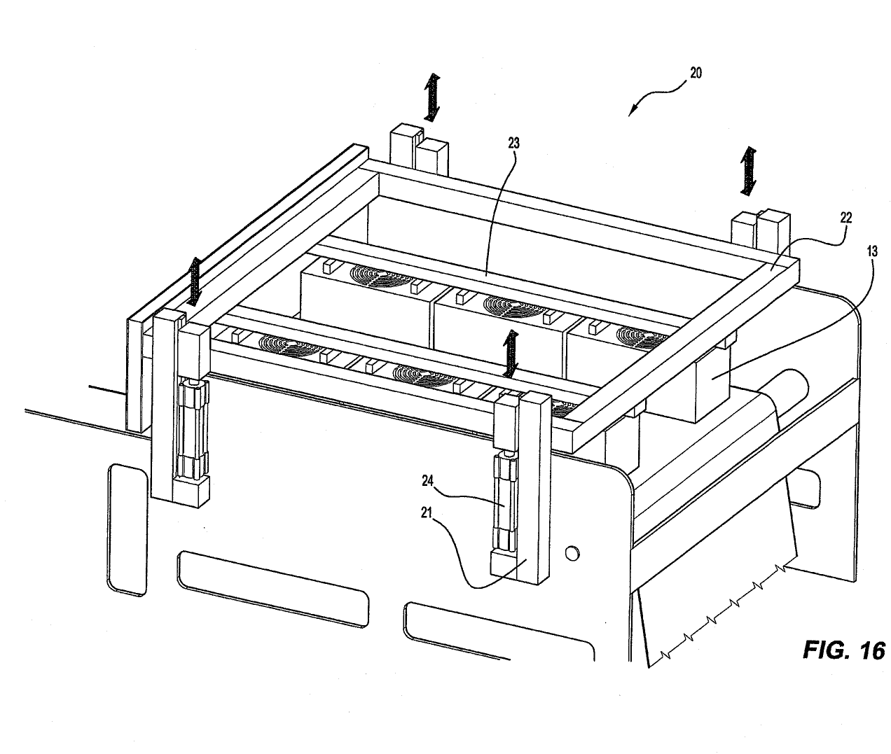

FIG. 15 shows maintenance extension of the lateral slide carriage.

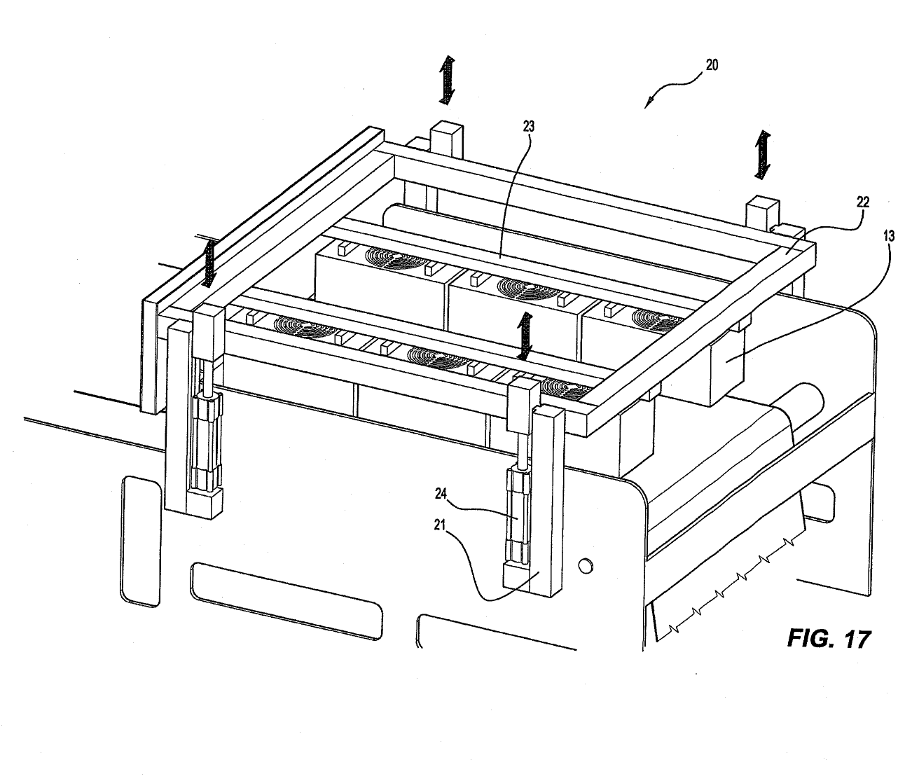

FIGS. 16 and 17 show the dryer gantry.

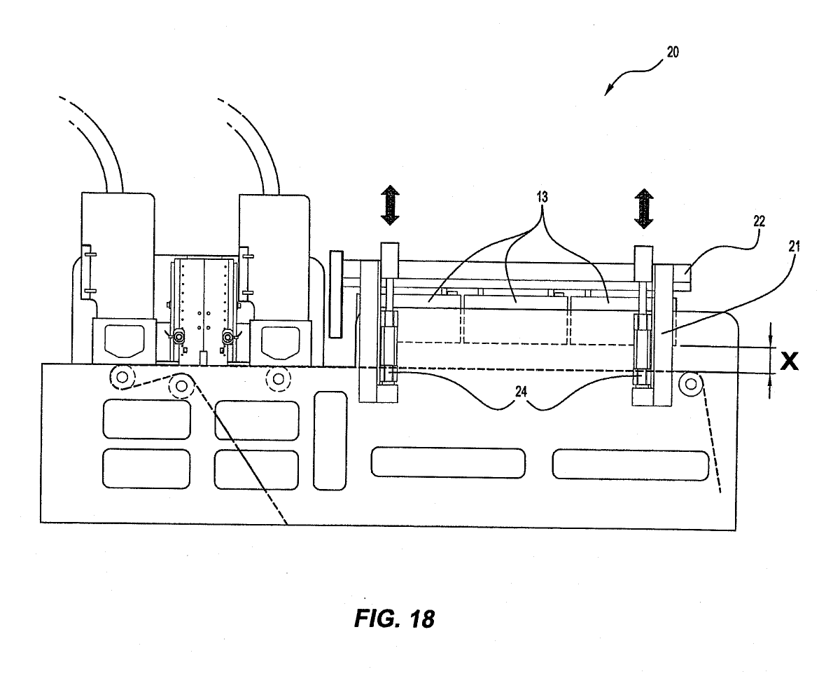

FIG. 18 shows vertical adjustment of the dryer gantry.

### LEGEND

1 Mounting means

2 Reel stand/splicer

3 Web press printing units

4 Printhead Gantry

5 Paper/Substrate

6 Printhead

7 Mounting carriage

8 Lateral slides

9 Lateral adjustment screw

10 Rollers

11 Head rollers

12 Slide lock

13 Dryers

14. Mounting bucket

20 Dryer gantry

21 Vertical risers

22 Transverse rails

23 Longitudinal mount

24 Vertical adjustment ram

25 Lateral slide carriage

26 First bar code reader

27 Second bar code reader

Referring firstly to FIG. 1, the integration of the continuous ink jet printhead or heads 6 as sourced from KODAK® and applied by way of the mounting means of the invention to an existing web offset press is shown in side view with the mounting means 1 of the invention conveniently positioned in available overhead space between the paper web or paper roll supply 2 and subsequent ink rollers 3 of an existing or primary web press.

The traditional configuration of a web offset press provides convenient overhead access in this region of the press componentary thereby allowing one or a plurality of continuous ink jet printheads to be retrofitted to an existing primary web press with minimal interference to the configuration of the existing press. In addition, the positioning and integration of the printheads at this early stage of the web press operating sequence allows the mounting means of the invention to access the paper flow with minimal interference thereby maximising the ability of the mounting means of the invention to maintain critical paper tension as it is subsequently delivered to the ink rollers of the web press. The mounting means of the invention allows the printheads to apply secondary printing to the paper (or other substrate) web and drying thereof prior to application of the primary printing as provided by the web press. Furthermore, the subsequent or downstream drying and processing operations of the existing web press can operate in the traditional manner without any requirements for modification or alteration whatsoever.

Referring to FIGS. 2 to 13, the mounting means 1 of the invention is shown in right and left perspective view in FIGS. 2 and 3 and includes a printhead gantry 4 adapted for positioning between the reel stand/splicer 2 and the first or subsequent print unit 3 of the press (as shown in FIG. 1). This region of the press traditionally includes a space to facilitate paper roll changes and provides a convenient “vacancy” in the otherwise busy chain of press components. The positioning of the printhead gantry 4 at this point allows the mounting means 1 to intercept and traverse the flow path of paper 5 passing from the paper web roll as it progresses to the first or subsequent print unit. The printhead or heads 6 are attached to the printhead gantry by way of a transverse mounting carriage 7 which is fitted to the printhead gantry by way of lateral slides 8. The printhead or printheads 6 are fitted to the mounting carriage 7 by placement in mounting buckets 14 dimensioned to receive the printhead 6. The mount buckets allow the printhead unit 6 to be readily fitted and interchanged to the carriage 7. Micro adjustment of the lateral position of the mounting bucket 14 (and associated printhead 6) is provided by way of a manual or servo driven lateral adjustment screw 9. In this manner, the printhead gantry and associated apparatus allows the printhead to be precisely positioned above the travel path of the paper web. The micro adjustment of the lateral adjustment screw allows the printhead to be brought into precise alignment as required relative to the paper travel path.

The mounting means includes a plurality of rollers 10 to intercept and direct the paper path from the reel stand/splicer 2 to pass beneath the printhead 6 and provide sufficient tensioning of the paper during interception so as to allow the paper to be redirected and fed back into the first or subsequent print unit 3 of the web press with sufficient control to allow the subsequent printing of the ink rollers and processing of the web press to proceed in the normal fashion.

The paper rollers 10 preferably include dedicated head rollers 11 specifically positioned directly underneath the printhead or heads 6 as shown in FIGS. 4 and 5 so as to ensure close and accurate alignment of the paper feed relative to the printhead to maximise the accuracy and provision of the continuous ink jet printing from the printhead. The dedicated head rollers 11 may be sufficiently wide to accommodate any lateral adjustment of the printhead and most preferably transverse the whole width of the mounting means as shown in the figures.

The tensioning means can be provided by co-operation of the rollers acting in concert. One particular configuration of tensioning is shown in FIGS. 5, 8 and 9 with reference to roller 10 which can adopt an idling function so as to take up and provide the necessary tensioning adjustments to the paper path without interfering with the precise positioning of the dedicated head rollers 11 which remain precisely aligned to the transverse travel path of the printheads 6.

The mounting means 1 provides for the accurate and precise alignment of a number of printheads 6 relative to the printhead gantries 4 to ensure accurate provision of the continuous ink jet secondary printing to the paper prior to primary printing by the ink rollers of the web press. The figures show two printheads mounted to the mount carriage 4, but two or more printheads can be fitted as required.

Referring to FIGS. 2 to 5 and 16 to 18, the mounting means further includes a dryer gantry 20 and associated dryers 13, specifically configured to intercept the paper after ink jet printing and dry the printing applied by the printheads prior to return of the ink jet printed paper to the printing units 3 of the web press.

The drying means may include one or more NIR infra red dryers positioned to co-operate with each printhead unit fitted to the mount means. The dedicated dryer gantry 20 is specifically configured to accommodate one or more dryers 13 for each printhead 6. The dryer gantry may include vertical risers 21 with transverse rails 22 fitted thereto. The dryers 13 are mounted to longitudinal mounts 23, spanning the transverse rails. Each transverse rail 22 has a lower transverse bearing track (not shown). The longitudinal mounts 23 and transverse bearing tracks co-operate via common linear bearings (not shown) to provide lateral movement of the dryers across the paper path. In this manner, each dryer 13 can be precisely positioned to dry the printhead output immediately post printing such that the paper 5 can be directly fed into the primary press.

The use of dedicated dryers allows the invention to apply the auxiliary personalised or versioned printing to any type of paper including sheet fed paper and other papers that require active drying prior to processing by the primary press and cannot rely on absorption as may be the case for highly absorptive news print paper and the like.

The dryer gantry 20 therefore accommodates a dryer or bank of dryers 13 for each printhead 6. The mobility provided by the dryer gantry allows each dryer to be positioned to align with each printhead. The alignment can be manual or in the case where the printheads are automated for transverse movement across the paper path, the dryer gantry may also be provided with servo assistance acting on a lateral adjustment screw to automate the dryer gantry to align the dryers with any movement of the printheads.

Referring now to FIGS. 10 through to 15, the printhead gantry 4 can be seen to include a lateral slide carriage 25 positioned either side of the gantry. The lateral slide carriage incorporates the lateral slides 8 for receiving and co-operating with the mounting carriage 7 with the lateral slide carriage per se being independently slidable relative to the printhead gantry 4. The lateral adjustment screw 9 is preferably mounted directly to the lateral slide carriage 25 so as to allow micro-adjustment of the mounting carriage 7 relative to the lateral slide carriage 25 and hence to the printhead gantry 4. The rotation of the lateral adjustment screw 9 either by manual or automated means provides for a highly precise movement and adjustment of the mounting bucket 14 across the paper path and hence provides for the accurate alignment of the printhead 6 for printing to the paper 5.

In a particularly preferred embodiment, the mounting means of the invention may include motorized micro lateral adjustment screws 9 which allow automation of the lateral adjustments of the printheads 6. Similar micro lateral adjustment screws can be provided and motorised for the dryers (not shown) on the dryer gantry. In addition, in a particularly preferred embodiment, automated counters can be provided on the head rollers 11 to allow ready monitoring of the paper passage past the printheads so as to assist in the provision of suitable automation of the printheads. In this manner, the mounting means of the invention can be programmed to apply specific batches of ink jet printing to a production run of the web press without the need to stop or in any way interfere with the continuous operation of the web press, thereby allowing a plurality of sub-batches and secondary printing to be applied to a continuous primary print run of an web press.

In addition to the embodiment given in the figures where the mount means moves the printheads and dryers across the top of the paper portion, the invention includes provision for the mount means to move the printheads and/or associated dryers across the underside of the paper path. In this manner, the invention allows printheads to apply printing to both sides of the paper prior to entry to the main press. The versatility of the invention therefrom allows maximum use of the printhead flexability to apply printing to the substrate in a wide variety of configurations prior to mainstream printing.

Referring to FIG. 14, in order to facilitate ease of maintenance of the printhead 6, the printhead mounting carriage 7 is mounted to the printhead gantry 4 by way of lateral slides 8. The lateral slides 8 are in turn mounted to a lateral slide carriage 25 such that activation of a slide lock 12 allows the mounting carriage 7, the lateral slide carriage 25 and associated printhead 6 to be moved transversely across the printhead gantry, which remains fixed to the press, and away from the paper feed path so as to allow direct access to the printhead from above and beneath, free from interference with the primary web printing apparatus whilst maintaining the alignment of the printhead 6 to the carriage 7. Once any maintenance is complete, the printhead 6 can be returned directly to the previous position by returning of the carriage 7 along the lateral slide carriage 25 so as to re-engage the slide lock 12 and return the printhead to its previous position. In this manner, the mounting means of the invention allows for ready, routine maintenance without the requirement for adjustment or unnecessary loss of production time.

In a particularly preferred embodiment, the invention can incorporate bar code readers or scanners enabling the automated separation of different versions of ink jet printing processed via the modified press of the invention. The first bar code reader is preferably positioned downstream of the primary printing press on the post press conveyor line, with the first bar code reader preferably positioned immediately after the folder/delivery section of the primary printing press In this manner, the bar code applied by the ink jet printing head onto the separator pages of the substrate can be read by the bar code reader downstream of the primary printing press as shown schematically in FIG. 1. With the aid of the bar code reader or scanner, once the bar code is intercepted on the conveyor after printing it can be automated to trigger a waste dump gate to open on the post press conveyor line. The opening of the waste dump gate automatically creates a gap in the substrate feed on the conveyor so as to separate each ink jet printed version from subsequent and following ink jet printed versions. In this manner, any number of shorter runs applied by the ink jet printers can be automatically separated for ease of separation and distribution once the printing has been accomplished.

In another particularly preferred embodiment, a second bar code scanner 27 can be positioned downstream of the primary printing press on the post press conveyor line and preferably immediately prior to the bundle stacker (not shown). In this way, the stacker can be programmed to interpret the bar code and eject an identified bundle and thereby automatically separate out the various versions of the print run as applied by the ink jet printing.

With this particular embodiment it is possible to adapt the invention so as to automate the handling and separation of any number of separate ink jet printed version runs on the post press conveyor line. The reading and automation of the bar code readers with the aid of a device designed to hold back several copies so as to create a gap in the continuous stream of substrate production and the subsequent automated separation and stacking of the respective versions thereby saving manual labour and eliminating waste as previously generated in the manual separation and handling of the different print versions.

In addition, version marking ID can also be applied on at least 2 sides of the finished bundles with the version information (ID) of what that particular bundle contains. This can be carried out with the use of an inexpensive ink jet unit or a label applicator or similar appropriate equipment mounted on the post press conveyor line after the counter/bundle stacker unit.

The version ID would be contained in the same bar code that is used to create the gap between the versions and operate the counter/bundle stacker. This encoded information would then drive the printer/applicator and cause it to mark the bundles with the appropriate version ID.

The mounting means and methods of the invention provide for the first time a comprehensive integration of the recently developed ink jet printheads with traditional web presses with the ink jet printheads being conveniently positioned early in the web printing schedule immediately after drawing off of the paper web from the supply roll. In this manner, the mounting means of the invention allows for the convenient positioning of the continuous ink jet printheads at the front end of the web sequence which generally allows access and available space prior to the application of the primary ink rollers and subsequent processing apparatus associated with a web press. The secondary printing can then be applied and dried early in the sequence and avoid any interference whatsoever with the established set up and post printing processing associated with existing web presses. The mounting means of the invention allows ready and convenient integration and retrofitting, minimising any physical interference with existing web offset and other presses using printing methods including gravure, flexography and letterpress printing set ups and eliminating any change of procedures post printing processing, thereby maximising efficiency of existing web printing installations.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A mounting arrangement for integrating at least one ink jet printhead with a primary press for printing on a substrate fed into the primary press prior to application of primary printing by the primary press, said mounting arrangement comprising:
a printhead gantry adapted for positioning the mounting arrangement intermediate an infeed unit of the substrate to the primary press and a print unit of the primary press,
a mounting carriage fitted to said printhead gantry and adapted to receive and position said at least one ink jet printhead for movement across a path of the substrate to intercept the substrate fed from the infeed unit,
dryers associated with each ink jet printhead for movement corresponding to movement of said at least one ink jet printhead across the path of the substrate adapted to dry an ink jet printed substrate prior to application of primary printing by the primary press,
rollers adapted to intercept and direct the substrate fed from the infeed unit past said at least one ink jet printhead and said dryers, and
a tensioning arrangement to return the ink jet printed substrate to the primary press under tension.

2. A mounting arrangement according to claim 1 further including a dryer gantry adapted to receive and position said dryers for co-operation with each ink jet printhead.

3. A mounting arrangement according to claim 1 wherein said printhead gantry includes a transverse mounting carriage fitted thereto for fitting said at least one ink jet printhead.

4. A mounting arrangement according to claim 3 wherein said transverse mounting carriage is positioned for movement of said at least one ink jet printhead over the path of said substrate.

5. A mounting arrangement according to claim 3 wherein said transverse mounting carriage is positioned for movement of said at least one ink jet printhead under the path of the substrate.

6. A mounting means according to claim 3 wherein said transverse mounting carriage directs the substrate over a top of said at least one ink jet printhead and then back under the at least one ink jet printhead in a reverse direction to ink jet a reverse side of the substrate.

7. A mounting arrangement according to claim 3 wherein said printhead gantry includes a lateral slide carriage incorporating slides for fitting said transverse mounting carriage to allow said at least one ink jet printhead to be moved between a printing position one of over and under the path of the substrate and a maintenance position away from the path of the substrate.

8. A mounting arrangement according to claim 7 wherein said lateral slide carriage includes a lateral adjustment screw for positioning said at least one ink jet printhead across the substrate path.

9. A mounting arrangement according to claim 8 wherein said lateral adjustment screw is motorized.

10. A mounting arrangement according to claim 2 wherein said dryer gantry includes transverse rails for mounting said dryers for positioning across the substrate path.

11. A mounting arrangement according to claim 10 wherein said transverse rails include a motorized lateral adjustment screw.

12. A combination of a primary press for applying primary printing to a substrate and an ink jet printhead for applying secondary printing to the substrate, wherein said at least one ink jet printhead is integrated with said primary press via a mounting arrangement in accordance with claim 1.

13. A method of integrating an ink jet printhead to a primary press including the use of a mounting arrangement according to claim 1 to mount at least one ink jet printhead to said primary press.

14. A mounting arrangement according to claim 3 wherein the mounting arrangement is integrated into a web press having a speed range of up to 4000 feet per minute, including commercial heat set printing presses.

15. A mounting arrangement according to claim 3 wherein the mounting arrangement is integrated into one of a manual or and servo driven lateral adjustment arrangement allowing precise positioning of said at least one printhead transversely across the path of the substrate adapted to one of manually and automatically gain one of registration and fit of ink jet images to themselves and then to subsequent host web printed images.

16. A mounting arrangement according to claim 1 further including a first bar code reader positioned to intercept the substrate after printing by said at least one ink jet printhead.

17. A combination of a primary press for applying primary printing to a substrate, an ink jet printhead for applying secondary printing to the substrate to produce a printed substrate, and a bundle stacker for the printed substrate, wherein said printhead is integrated with said primary press via a mounting arrangement in accordance with claim 16 and further including a second bar code reader positioned to intercept the substrate immediately prior to said bundle stacker.

18. A mounting arrangement according to claim 1, wherein:
the primary press includes one of:
a heat set web offset press,
a sheet press,
a gravure press,
a flexographic press,
a cold set press and
a heat set press;
the infeed unit of the primary press includes one of:
a reel stand/splicer and
a feeder;
the print unit of the primary press includes one of:
a first print unit and
a subsequent print unit.
